(19) United States
(12) Patent Application Publication
(10) Pub. No.: US 2015/0174708 A1
(43) Pub. Date: Jun. 25, 2015

(54) Tool and Device for Cold Expansion of Holes

(71) Applicants: Yordan MAKSIMOV, Gabrovo (BG); Galia DUNCHEVA, Gabrovo (BG)

(72) Inventors: Yordan Maksimov, Gabrovo (BG); Galia Duncheva, Gabrovo (BG)

(21) Appl. No.: 14/415,709

(22) PCT Filed: Jul. 18, 2013
(86) PCT No.: PCT/BG2013/000034

§ 371 Date: Jan. 19, 2015

(30) Foreign Application Priority Data
Jul. 20, 2012 (BG) 111269

(51) Int. Cl. B23P 9/02; B21D 31/04

(52) U.S. Cl. CPC B23P 9/025; B21D 31/04

(57) ABSTRACT

The invention refers to a tool and device for cold expansion of holes. The tool comprises a mandrel (1) split so, that at least three symmetrical segments (49) are formed in it. In an axial hole (8) of the mandrel a mobile pin (3) is positioned, and the working part of the mandrel is formed by two conical surfaces, connected by one round surface. The device comprises a cylinder (4) with a piston (5) and a piston rod (6), to the end of which the mandrel (1) is clamped, a second piston (10), inserted in a hole (8) in the piston (5) and the piston rod, connected to a second piston rod, the end of which is statically clamped to the pin. The tool and device provide one and the same tightness between the mandrel and the machined holes and reduce the number of technological operations.

### TECHNICAL FIELD

The invention refers to a tool and device for cold expansion of holes, providing one and the same tightness between the deforming tool and the preliminary drilled holes with a relatively wider tolerance of their diameter dimension. It can find application for machining of holes in construction elements from elastic plastic materials, afterwards exposed to cyclic external loading; thus it is especially suitable for cold expansion of rail-end-bolt holes of railway rails.

### BACKGROUND ART

From U.S. Pat. No. 4,665,732 a tool is known for cold expansion of holes, comprising a mandrel, partially longitudinally split so, that at least three symmetrical segments of the mandrel are formed; in an axial, completely round mandrel hole a round axially movable pin is inserted. The working part of the mandrel, deforming the machined hole, is formed by outer conical and round surfaces.

Also from U.S. Pat. No. 4,665,732 a device is known for cold expansion of holes, in which a first piston with a piston rod is inserted, to the end of which the longitudinally split mandrel of the tool is clamped. In an axial hole, machined in the first piston and its piston rod, a second piston rod is inserted, the end of which is connected to the pin. A second piston, connected to the second piston rod, is inserted in a second cylinder, coaxial to the first and connected to it. The first cylinder comprises one hydraulic and one pneumatic chamber. The first piston, the first piston rod and the first cylinder form a power hydraulic chamber. The first piston, the second piston, the second piston rod and the first cylinder form the first pneumatic chamber. The second cylinder and the second piston form the second pneumatic chamber. The device is provided with power hydraulic and controlling pneumatic systems. The power hydraulic system comprises a hydraulic pump, driven by a pneumatic motor, and is connected to a pneumatically controlled hydraulic distributor. The said is connected to the hydraulic chamber of the device. A relief valve is provided for unloading the pump. The pneumatic control system includes an air pressure source, directly connected to the first pneumatic chamber, maintaining a constant pressure of 100 psi in it. The air pressure source is also connected to a logical air valve, which in its turn is connected to the second pneumatic chamber and to a “throttle control-check valve” unit (TCCV). The said is connected to a second air valve, controlling the pneumatic motor, and to the hydraulic distributor. TCCV provides delay in time between the opening of the logical air valve and the second air valve.

When machining fastener holes with the known tool and device, the of cold expansion of the hole depends only on the diameter dimensions of the mandrel and pin, and on the diameter of the preliminary drilled hole. In order to guarantee the tightness (defined with the respective tolerance) between the mandrel, deforming the hole, and the preliminary drilled hole, it is necessary to control the diameter of the preliminary drilled hole, as well as the working part of the “tightened” mandrel by geometric criterion—by means of gauges. The axial opening of the mandrel, in which the round pin is positioned, is controlled in the same way. All this leads to increase in the number of operations in the technological process, respectively to increase of the machining cost. If the rail end bolt holes of the railway rails are cold expanded with the known tool and device, a preliminary machining of the holes, ensuring a very narrow tolerance of the diameter dimension is necessary, and this substantially increases the cost of the technological process.

### SUMMARY OF INVENTION

The task of the invention is to develop a tool and device for cold expansion of holes, providing one and the same tightness between the deforming mandrel and the preliminary drilled holes by relatively bigger tolerance of their diameter, smaller number of technological operations and thus reduced machining cost.

The task is solved, as a tool for cold expansion of holes is developed. It comprises a mandrel, longitudinally split so, that at least three symmetrical segments are formed, and a round axially movable pin is inserted in an axial hole of the mandrel.

The working part of the mandrel is formed by two conical surfaces, connected to each other by a round surface. The one end of the round pin has conical surface, contacting the surface of a conical hole, machined in the split end of the mandrel, and the two conical surfaces have one and the same inclination angle α and expand in direction to the split end of the mandrel. The working conical surface of the mandrel working part turns into round surface of the mandrel. Each segment of the working part of the mandrel, through its conical surface, contacts the conical surface of the pin only by one forming line, lying in the symmetry plane of the respective segment, for each reciprocal position in axial direction of segments and pin. The unsplit part of the mandrel is threaded for connecting the tool to the device. The second pin end is adjusted to the device separately from the mandrel through a thread joint or in another suitable way.

Another embodiment of the tool is to split the mandrel entirely, from one end to the other, in separate segments contacting laterally without clearance. The segments are set with the only possibility of radial moving in a cylinder threaded sleeve that has internal thread for joining the tool to the device. A second conical surface is machined on the pin; that surface contacts the second conical surface of the axial hole of the mandrel. The two conical surfaces expand in the same direction as the conical surface at the one end of the pin, and have the same inclination angle α. The second conical surface is made of sectors statically clamped to the respective segments. An elastic element with radial direction of elasticity is inserted between an outer round surface, machined on the segments, and an inner round surface, machined on the sleeve. One or more elastic elements for retracting the segments in their primary position after their shift in radial direction is/are clamped round the outer round surfaces of the segments. A hole that is subject to cold expansion is preliminary drilled with the respective tolerance in the workpiece; the surface of this hole is the enveloping round surface of the rotational outer segment surfaces, which form a discrete outer round surface, coinciding with the enveloping round surface of the preliminary drilled hole, when this hole is drilled at the upper limit of the diameter tolerance. Each sector, through its conical surface, contacts the second conical pin surface only by one forming line, lying in the symmetry plane of the respective sector—for each reciprocal position in axial direction of the sectors and the pin, with the exception of the reciprocal position, corresponding to the case, when the machined hole is preliminary drilled at the upper limit of its diameter tolerance.

Another embodiment of the tool is provided for, in which α angle is smaller or equal to the angle of friction between the respective contacting conical surfaces of the pin and the mandrel.

The task is also solved with a device for cold expansion of holes, comprising a hydraulic cylinder, in which a first piston with a piston rod is inserted, to the end of which, through its unsplit part, the mandrel of the tool is coaxially clamped. In an axial hole, machined in the piston and the piston rod, a second piston is inserted, connected to a second piston rod, the end of which is statically connected to the pin. In the same hole, on the side of the mandrel, a distance sleeve is statically placed. A spring, working under pressure, is placed between the second piston and the sleeve.

The front faces of the first and second piston, the surface of the axial hole in the first piston, the surface of the cylinder, the front and inner round faces of the sleeve and the front face of the cylinder bottom form a joint piston chamber. A flange is coaxially statically clamped to the cylinder in direction to the split end of the mandrel. This flange contacts with the machined workpiece in the process of pulling the mandrel through the machined hole. The inner round surface of the flange limits the maximal diameter of the round surface, circumscribed around the round surfaces of the working part of the mandrel, after the said is pulled through the machined hole. A shoulder, limiting the piston stroke, is provided for between the first piston and the cylinder bottom.

The device also has a driving-control system, comprising a hydraulic pump, serially connected to a relief-easing valve and to a central hydraulic distributor, controlled by two electromagnets through an instruction-control unit (ICU). The hydraulic distributor is connected to the piston chamber of the hydraulic cylinder through a serially connected first “throttle control-check valve” (TCCV) unit and a second hydraulically controlled distributor. A rod chamber, formed by the cylinder, the first piston and its piston rod, is connected to the central hydraulic distributor via a second “throttle control—check valve” unit (TCCV). A check valve and a flow regulator are serially connected between the central and the second hydraulic distributors.

According to the invention another embodiment of the device is provided for: the front face of the second piston, limited by the second piston rod, the round surface of the second piston rod, the axial hole surface in the first piston and the front face, limited by the axial hole in the first piston and in the first piston rod, form a second rod hydraulic chamber. Through a radial hole, machined in the first piston rod, the second rod hydraulic chamber is connected to a distributing hydraulic chamber, coaxial to the second rod chamber, and formed by the round surface of the first piston rod, the concentric round surface of the cylinder and the two front faces, machined in the housing of the hydraulic cylinder. The axial length of the distributing hydraulic chamber is bigger than the axial stroke of the first piston.

The device also has a driving-control system, comprising a hydraulic pump, serially connected to a relief-easing valve and to a central hydraulic distributor, controlled by two electromagnets via an instruction-control unit (ICU). The hydraulic distributor is connected to the piston chamber of the hydraulic cylinder. The rod chamber of the hydraulic cylinder is connected to the hydraulic distributor via two parallel circuits. The first circuit comprises a serially connected throttle, a check valve and a second check valve. The hydraulic distributor is connected to a tank via filter. The second circuit, in direction from the hydraulic distributor to the rod chamber, comprises a serially connected relief valve, a hydraulically controlled distributor, a flow regulator and a check valve. A second check valve, providing the control of the hydraulically controlled distributor, is parallel connected to the relief valve. By analogy, the second rod chamber is connected to the central hydraulic distributor and to two other parallel circuits. The first one comprises a relief valve and a hydraulically controlled distributor. The second circuit, in direction from the central hydraulic distributor to the second rod chamber, comprises a hydraulically controlled distributor, a throttle and a check valve.

According to the invention a third embodiment of the device is provided for. In it a cylinder sleeve is machined or statically coaxially clamped to the first piston; this sleeve is set in a lid hole, which via thread or other suitable way is connected to a hydraulic cylinder. The tool pin is inserted in the axial hole of the cylinder sleeve so, that the outer surface of the sleeve, the inner surface of the cylinder, the front face of the piston and the bottom lid form the piston chamber. A second hydraulic cylinder is coaxially machined or statically clamped to the cylinder sleeve; the second piston is set in this second cylinder, and the tool pin is statically clamped to this second piston rod. The second cylinder is closed by lid. The said, together with the front face of the second piston and the second cylinder, form a second piston chamber. The driving control system of the device is executed by analogy with the above-mentioned embodiment with one piston and two rod chambers.

According to the invention the advantage of the tool and device is the possibility of providing one and the same tightness between the deforming mandrel and the preliminary drilled holes with at least twice bigger diameter tolerance and decreased number of technological operations and machining cost. In spite of the greater dispersion of the preliminary drilled holes dimensions, one and the same tightness between the hole and the machining mandrel is guaranteed. Respectively, a relatively wider diameter tolerance of the preliminary drilled hole is allowed, and no gauge check is necessary. In this way the hole-enlarging operation immediately after drilling can be eliminated. The tool and device are especially suitable for cold expansion of rail end bolt holes of railway rails.

### BRIEF DESCRIPTION OF DRAWINGS

FIG. 1 shows a longitudinal section of the tool and device, executed with one piston and one rod chambers, when the tool is inserted in the preliminary drilled hole;

FIG. 2a—a longitudinal section of the tool and device immediately before pulling of the tool through the hole starts;

FIG. 2b—cross section in A-A of FIG. 2a;

FIG. 3—longitudinal section of the tool and device when the process of pulling the tool has begun;

FIG. 4—longitudinal section of the tool and device after the working part of the tool has gone out of the machined hole;

FIG. 5—a longitudinal section of execution of the tool, working under purely radial shift of the segment;

FIG. 6—a cross section in A-A of FIG. 5 in starting position of the segments when the tool is inserted into the hole;

FIG. 7—a cross section of the tool in A-A of FIG. 5 in segment position after pulling of the tool has started;

FIG. 8—a longitudinal section of execution of the device with one piston and two rod chambers;

FIG. 9—a longitudinal section of execution of the device with two piston and two rod chambers;

FIG. 10—a scheme of the driving-control hydraulic system of the tool, as per FIG. 1

FIG. 11—a scheme of the driving-control hydraulic system for embodiment of the device as per FIG. 8;

FIG. 12—a scheme of the driving-control hydraulic system for embodiment of the device as per FIG. 9.

### DESCRIPTION OF EMBODIMENTS

The invention is explained by the following exemplary embodiments, without being limited by them:

### Embodiment 1

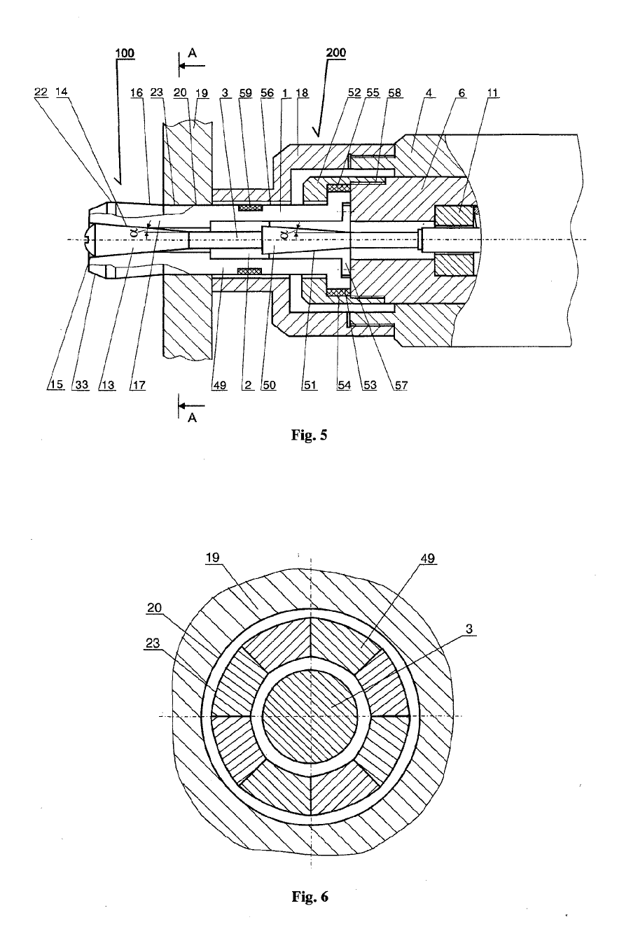

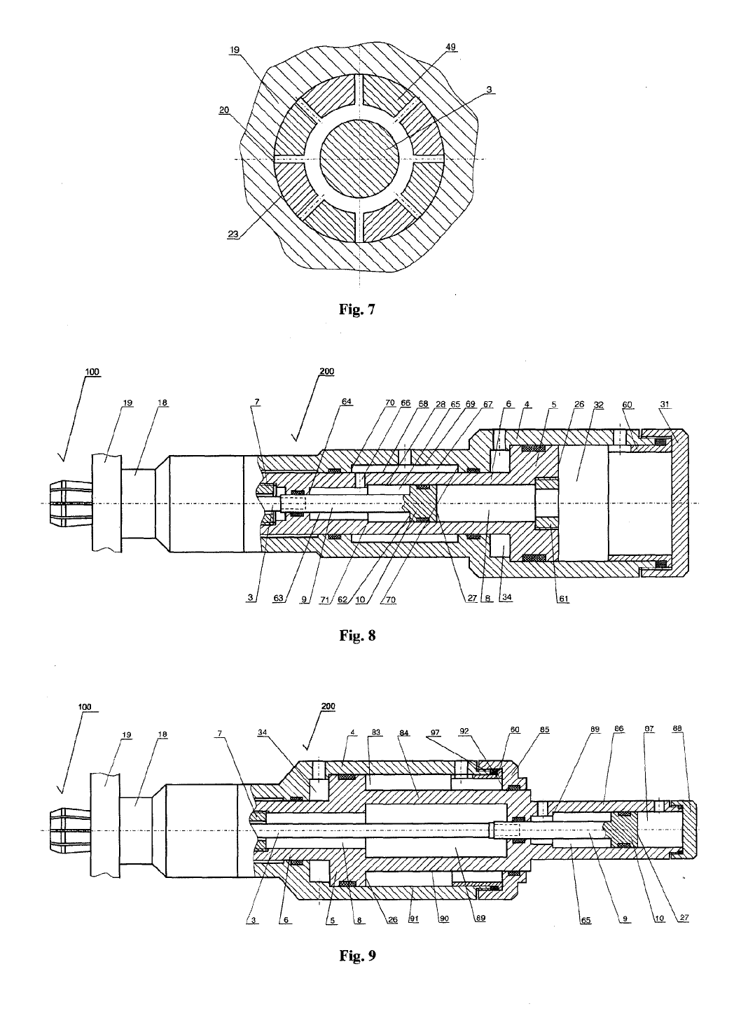

A tool 100 has been created for cold expansion of holes (FIGS. 1 and 5). It comprises a mandrel 1, longitudinally partially split so, that eight symmetrical segments 49 of mandrel 1 are formed, in the axial hole 2 of which a round axially travelling pin 3 is positioned.

The working part 17 of mandrell is formed by conical surfaces 16 and 33, connected to each other by round surface 22. The one end of round pin 3 has conical surface 13, contacting surface 14 of conical hole 15, machined in the split end of mandrel 1, as the two conical surfaces 13 and 14 have one and the same inclination angle α and expand in direction to the split end of mandrell. The working conical surface 16 of the working part 17 of mandrel 1 goes into round surface 23 of mandrel 1. Each segment 49 of the working part 17 of mandrel 1, through its conical surface 14, contacts the conical surface 13 of pin 3 only by one forming line, lying in the plane of symmetry of the respective segment, for each reciprocal position in axial direction of segments 49 and pin 3. Thread 25 is cut on the unsplit part 7 of mandrel 1, which would connect tool 100 to device 200. The second end 93 of pin 3 is attached separately from mandrel 1 to device 200 through thread joint 94.

### Embodiment 2

An embodiment of tool 100 for cold expansion of holes (FIG. 5) is developed, in which mandrel 1 is entirely split, from the one end to the other, into separate segments 49, touching each other laterally without clearance. The segments are set with the possibility of only radial shift in a cylinder threaded sleeve 52, with thread 58 cut in it for connecting tool 100 to device 200. A second conical surface 50 is machined on pin 3, contacting the second conical surface 51 of axial hole 2 of mandrel 1. The two conical surfaces 50 and 51 are expanded in the same direction, as the conical surface 13 from the one end of pin 3, and have the same inclination angle α. The second conical surface 51 is made by sectors 57, statically clamped to the respective segments 49. An elastic element 55, with elasticity in radial direction, is inserted between outer round surface 53, machined on segments 49, and inner round surface 54, machined on pin 52. Around the outer round surfaces 56 of segments 49 one or more elastic elements 59 are clamped, which to retract segments 49 in their primary position, after their shift in radial direction. The surface 20 of the preliminary drilled (with the respective tolerance) hole in workpiece 19, which is to be cold expanded, is a enveloping round surface of the rotational outer surfaces 23 of segments 49. These surfaces 23 form a discrete outer round surface, coinciding with the enveloping round surface 20 of the preliminary drilled hole—when this hole is drilled at the upper limit of its diameter tolerance. Each sector 57, through its conical surface 51, contacts the second conical surface 50 of pin 3 only by one forming line, lying in the plane of symmetry of the respective sector, for each reciprocal position in axial direction of sectors 57 and pin 3. There is one exception: the reciprocal position, corresponding to the case, when the hole to be cold expanded is preliminary drilled at the upper limit of its diameter tolerance. In this case the contact is surface to surface. In this way the disadvantageous “edge” contact—surface to edges—is eliminated. The same condition is also fulfilled for the contact between conical surfaces 14 of segments 49 and conical surface 13 of the free end of pin 3.

### Embodiment 3

An embodiment of tool 100 is developed with keeping the construction peculiarities, described in said embodiments 1 and 2. In this version the α angle is smaller or equal to the friction angle between the respective contacting conical surfaces of pin 3 and mandrel 1.

### Embodiment 4

Embodiments of tool 100 are developed on keeping the construction peculiarities, described in said embodiments 1 and 2, with the exception, that the number of segments 49 is from 2 to 7 or from 9 to 16, including.

### Embodiment 5

A device for cold expansion of holes (FIG. 1) is developed, comprising a hydraulic cylinder 4, in which a first piston 5 with a piston rod 6 is inserted. Mandrel 1 of tool 100 is coaxially clamped through its unsplit part 7 to this piston rod. In an axial hole 8, machined in piston 5 and in piston rod 6, a second piston 10 is inserted, connected to a second piston rod 9, the end of which is statically connected to pin 3. In the same hole 8, to the side of mandrel 1, a distance sleeve 11 is statically set. A spring 12, working under pressure, is inserted between the second piston 10 and the sleeve 11.

The front faces 26 and 27 of the two pistons 5 and 10, surface 28 of the axial hole 8 in the first piston 5, surface 29 of cylinder 4, surfaces 95 and 96 of sleeve 60 and the front face 30 at the bottom 31 of cylinder 4 form a joint piston chamber 32. Coaxially to cylinder 4, in direction to the split end of mandrel 1, a throttle 18 is statically clamped, contacting the machined workpiece 19 in the process of pulling mandrel 1 through machined hole 20. Its inner round surface 21 limits the maximal diameter of the circumscribed round surface around surfaces 22 of the working part 17 of the split mandrel 1, after the said is pulled through the hole 20. A shoulder 24 is provided for between the first piston 5 and the cylinder bottom 4, limiting the stroke of piston 5.

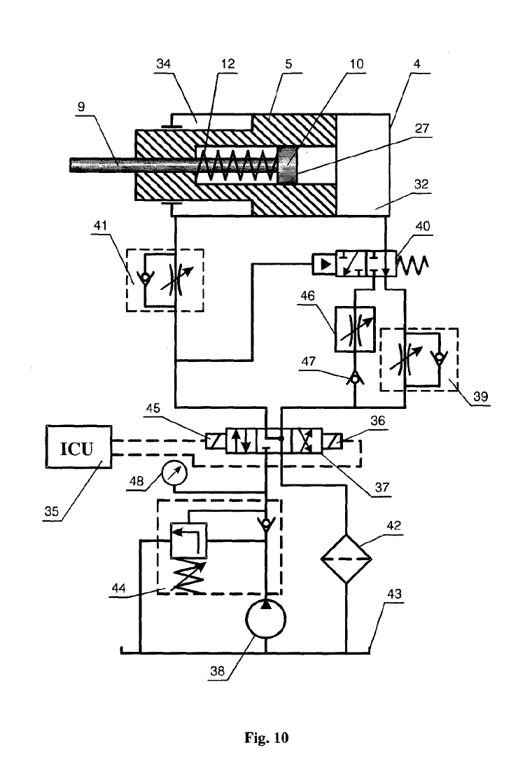

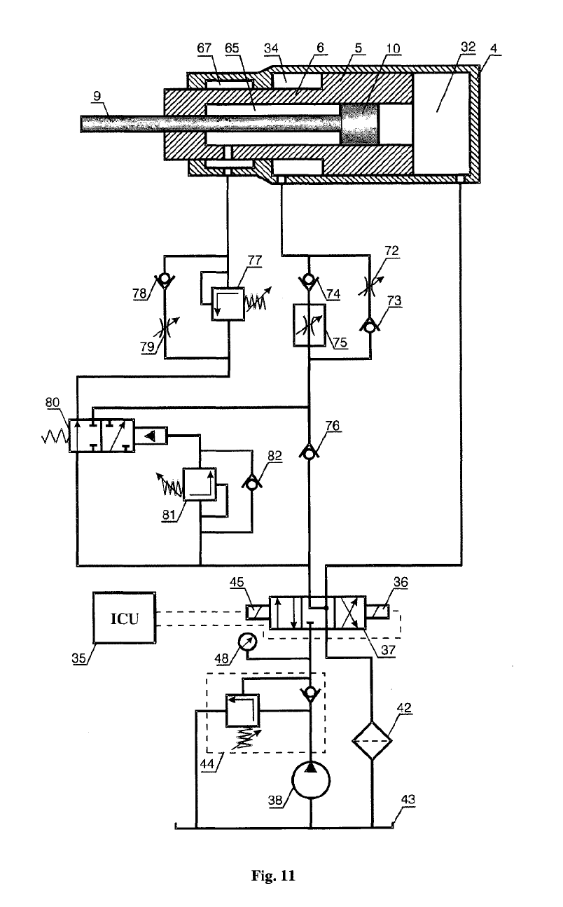

The device also comprises a driving-control system (FIG. 10), consisting of a hydraulic pump 38, serially connected to a relief-easing valve 44 and to a central hydraulic distributor 37, controlled by electromagnets 36 and 45 via instruction-control unit (ICU) 35. The hydraulic distributor 37 is connected to piston chamber 32 of hydraulic cylinder 4 via a serially connected first unit “throttle control-check valve” (TCCV) 39 and a second hydraulically controlled distributor 40. The rod chamber 34 is connected to the hydraulic distributor 37 via a second unit “throttle control-check valve” (TCCV) 41. A check valve 47 and flow regulator 46 are serially connected between the two hydraulic distributors 37 and 40. The working fluid, purified by filter 42, is gathered in tank 43. The fluid pressure at the pump exit 38 is read by manometer 48.

### Embodiment 6

According to the invention an embodiment of the device is developed (FIG. 8), in which surface 62 of the second piston 10, limited by the second piston rod 9, the round surface 63 of the second piston rod 9, surface 28 of axial hole 8 in the first piston 5 and front face 64, limited by axial hole 8 in the first piston 5 and in the first piston rod 6, form a second piston hydraulic chamber 65. Via a radial hole 66, machined in the first piston rod 6, the second rod hydraulic chamber 65 is connected to a distributing hydraulic chamber 67, coaxial to the second rod chamber 65 and formed by the round surface 68 of the first piston rod 6, the concentric round surface 69 from cylinder 4 and the two front faces 70, machined in the housing of hydraulic cylinder 4. The axial length of the distributing hydraulic chamber 67 is bigger than the axial stroke of the first piston 5, in order to guarantee constant connection between the two chambers through the radial hole 66.

The device also comprises a driving-control system (FIG. 11), consisting of a hydraulic pump 38, serially connected to a relief-easing valve 44 and to a central hydraulic distributor 37, controlled by electromagnets 36 and 45 via an instruction-control unit (ICU) 35. The hydraulic distributor 37 is connected to piston chamber 32 of hydraulic cylinder 4. The rod chamber of hydraulic cylinder 3 is connected to hydraulic cylinder 37 via two parallel circuits. The first circuit comprises a serially connected throttle 72, a check valve 73 and a second check valve 76. The hydraulic distributor 37 is connected to tank 43 via filter 42. The second circuit in direction from the hydraulic distributor 37 to chamber 34 comprises a serially connected relief valve 81, hydraulically controlled distributor 80, flow regulator 75 and check valve 74. Check valve 82, providing the control of distributor 80, is parallel connected to relief valve 81. By analogy, the second rod chamber 65 is connected to hydraulic distributor via two parallel circuits. The first of the two comprises a relief valve 77 and a hydraulically controlled distributor 80. The second circuit, in direction from hydraulic distributor 37 to inner rod chamber 65, comprises a hydraulically controlled distributor 80, a throttle 79 and a check valve 78.

### Embodiment 7

According to the invention (FIG. 9) an embodiment of the device is developed, in which a cylinder sleeve 84 is machined or statically clamped to the first piston 5. This sleeve is set in a lid hole 85, connected via thread 95 or flange joint to hydraulic cylinder 4. In the axial hole 89 of cylinder sleeve 84 pin 3 of tool 100 is inserted so, that the outer surface 90 of sleeve 84, the inner round surface 91 of cylinder 4, the front face 26 of piston 5 and the bottom 92 of lid 85 form piston chamber 83. A second hydraulic cylinder 86 is coaxially machined or statically clamped to cylinder sleeve 84. The second piston 10 is set in it, and to its piston rod pin 3 of tool 100 is statically clamped. The second cylinder 86 is closed by lid 88. The said, together with the front face 27 of the second piston 10 and the second cylinder 86 form the second piston chamber 87.

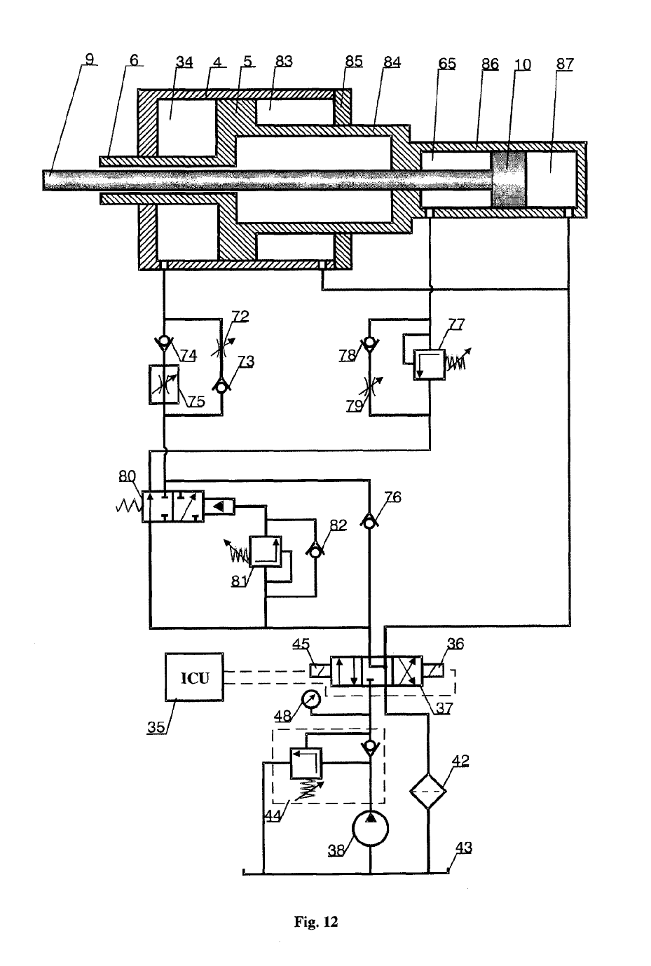

The device driving-control system (FIG. 12) is executed by analogy with the one in Embodiment 6.

### INDUSTRIAL APPLICABILITY

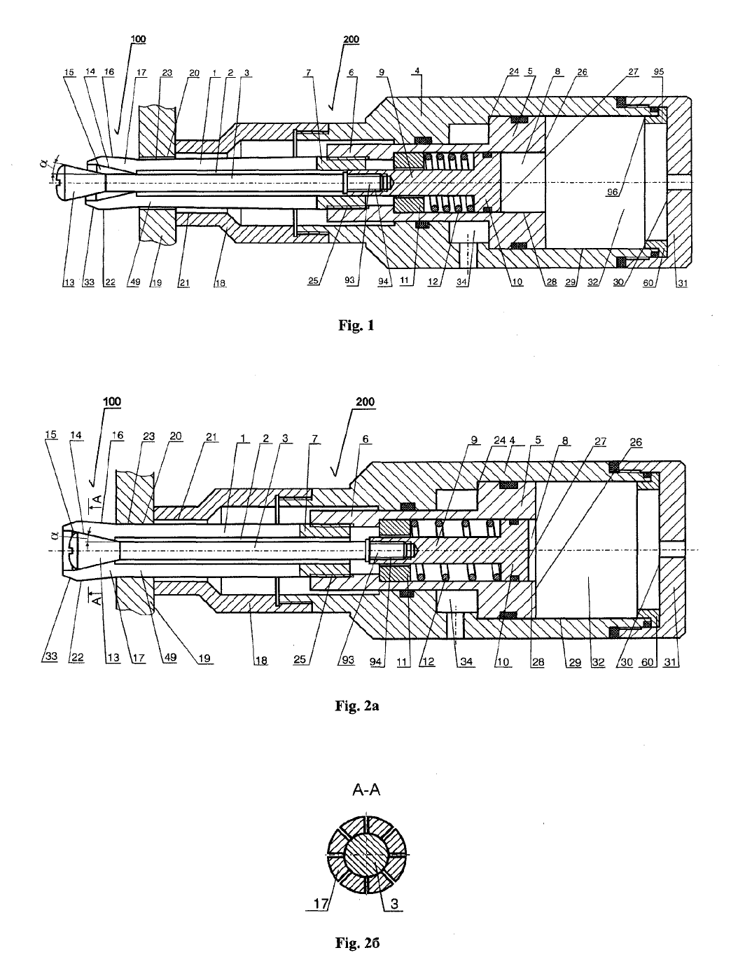

The cold expansion of holes through tool and device, providing one and the same tightness between the deforming mandrel and the preliminary drilled holes with a relatively wider tolerance of their diameter dimension is executed in the following way (FIGS. 1-4). The operator inserts mandrel 1 of tool 100 in preliminary drilled hole 20 of workpiece 19, until flange 18 closely contacts workpiece 19, which is facilitated by conical surface 33, machined on working part 17 of split mandrel 1—as it is shown on FIG. 1. There is a clearance between round surface 23 and hole surface 20. For this purpose electrical voltage is supplied from inspection-control unit 35 (FIG. 10) to electromagnet 36 of the hydraulic distributor 37, thus switching on its adjacent right section. This causes the working fluid, fed by pump 38 to pass through the right section of distributor 37, the check valve of the TCCV unit 39, the right section of distributor 40 and to enter piston chamber 32 of cylinder 4. Piston 5 starts moving in cylinder 4 in direction to workpiece 19, and together with piston 5, tool 100 also moves. The fluid, pushed from rod chamber 34, passes through the throttle control of TCCV unit 41, the left section of distributor 37, the filter 42 and enters tank 43. The motion speed is adjusted by the position of throttle control of TCCV unit 41. After piston 5 reaches extreme left position, i. e. contact with shoulder 24, the second piston 10, together with pin 3 of tool 100, continues moving in direction to workpiece 19, thus deforming spring 12, which works under pressure, until the elastic force in spring 12 is balanced by the force, resulting from the pressure in piston chamber 32, applied on surface 27 of piston 10. The round pin 3, clamped to piston rod 9 of piston 10, has axially moved in regard to mandrel 1 in direction to workpiece 19 so, that conical surface 13 of pin 3 does not contact conical surface 14 of mandrel 1 (FIG. 1). This allows for the segments 49 of the split mandrel 1 to be elastically deformed in radial direction towards its axis. In this way the operator can freely insert mandrel 1 in the preliminary drilled hole 20 of workpiece 19 (FIG. 1). After inserting mandrel 1 in hole 20 of workpiece 19, the electromagnet 36 is turned off and the middle section of distributor 37 is switched over. In result of the action of the elastic force in spring 12, the second piston 10 starts moving in reverse direction, away from workpiece 19. The round pin 3, which is connected to piston rod 9 of piston 10, moves together with piston 10. That makes the conical surface 13 of pin 3 contact the conical surface 14 of hole 15, machined in mandrel 1. The segments 49 of mandrel 1 move radially, away from the mandrel axis, in result of which the round surface 23 of mandrel 1 contacts hole 20 in workpiece 19. The radial shift of the working parts 17 of mandrel 1 stops after the radial pressure of the round surface 23 upon the surface of hole 20 is balanced by the elastic force of the spring 12 (FIG. 2). At that moment the diameter of the round surfaces 22 of the working parts 17 of mandrel 1 is bigger than the diameter of the preliminary drilled hole 20 in workpiece 19. The working fluid, pushed by piston 10 during its axial shift in direction away from workpiece, passes through piston chamber 32 of cylinder 4, through the throttle control of TCCV unit 39, the middle section of distributor 37, the filter 42 and enters tank 43. The motion speed of piston 10 is adjusted by the throttle control of TCCV unit 39. After reaching the pressure, for which the relief-easing valve 44 is set, the said opens and the hydraulic oil from pump 38 through valve 44 enters tank 43, in result of which the pump is released from pressure.

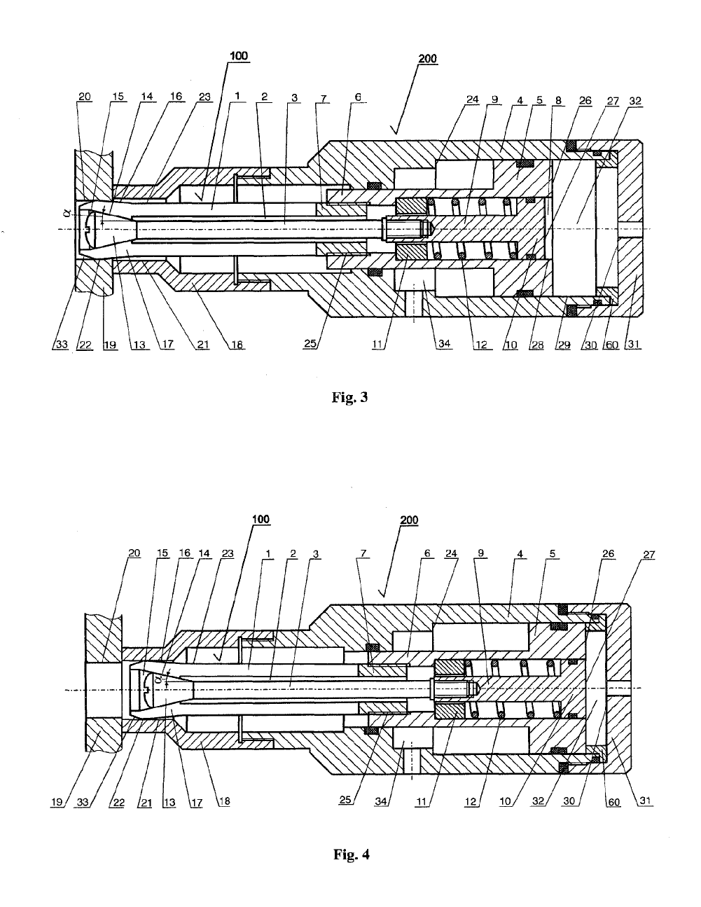

Electric voltage is supplied from ICU 35 to electromagnet 45 of distributor 37 and its adjacent left section is switched on. The working fluid fed by pump 38 passes through the left section of distributor 37, the check valve of TCCV unit 41 and enters rod chamber 34 of cylinder 4. The pressure is increased, in result of which the left section of distributor 40 is switched over. The piston 5 starts moving to the right, away from workpiece 19. Together with the piston 5 mandrel 1 also starts moving, with round pin 3. This causes the conical surfaces 16 and round surfaces 22 of the working parts. 17 of mandrel 1 to pass through the preliminary drilled hole 20 in workpiece 19, deforming it plastically (FIG. 3). The movement of piston 5 to the right is limited by sleeve 60. After the working parts 17 of mandrel 1 pass through hole 20, under the effect of the elastic force, retained in spring 20, piston 10 additionally moves away from workpiece 19. In this way it also shifts pin 3, until the round surfaces 22 of the working parts 17 of mandrel 1 touch the round surface 21 of flange 18 (FIG. 4).

After termination of the impact of mandrel 1 on hole 20, the mechanical particles of workpiece 19 naturally tend to their primary position, but they meet the counterforce of the dragged metal layer round hole 20, the diameter of which has increased. In result of the limited, impeded metal contraction, residual circumferential normal compression stresses arise around hole 20, which close the existing microcracks like a bracket and impede the formation of new ones.

The working fluid, pushed from piston chamber 32 of cylinder 4, passes through the left section of distributor 40, flow regulator 46, check valve 47, left section of distributor 37, filter 42 and enters tank 43. The motion speed of piston S is set by the adjustment of the flow regulator 46. After piston 5 reaches extreme right position, fixed by pin 60, the system pressure increases and the relief-easing valve 44 opens, so that the working fluid, fed by pump 38, passes through it and enters tank 43. A manometer 48 is provided for, as pressure indicator.

When the device is performed as per FIG. 8, after voltage supply by ICU 35 to electromagnet 36 of distributor 37 (FIG. 11), its adjacent right section is switched on. This causes the working fluid, fed by pump 38, to pass through the right section of distributor 37 and enter piston chamber 32 of cylinder 4. Piston 5, together with tool 100, starts moving to the right. The fluid, pushed from rod chamber 34, passes through throttle control 72, check valve 73, check valve 76, right section of distributor 37, filter 42 and enters tank 43. The motion speed is adjusted by the position of throttle control 72. After piston 5 reaches extreme left position, the system pressure increases and on its reaching the value, for which the safety valve 77 is adjusted, the said opens. This causes the inner piston 10, together with pin 3 of tool 100, to move to the left. The working fluid, pushed from the inner rod chamber 65 passes through the safety valve 77, the left section of distributor 80, the right section of distributor 37, the filter 42 and enters tank 43. The motion speed is adjusted by the position of throttle control 79. After piston 10 reaches extreme left position, the system pressure increases and the relief-easing valve 44 opens, so that the working fluid, fed by pump 38, passes through it and enters tank 43. The middle section of distributor 37 is switched over by ICU 35. After ICU 35 supplies voltage to electromagnet 35 of distributor 37, its adjacent left section is switched on. This causes the working fluid, fed by pump 38 to pass through the left section of distributor 37, the left section of distributor 80, the throttle control 79, check valve 78 and to enter the inner rod chamber 65. Piston 10 starts moving to the right together with pin 3 of tool 100, which causes the conical surface 13 of pin 3 to contact conical surface 14 of hole 15, machined in mandrel 1. The working parts 17 of mandrel 1 move radially, away from the mandrel axis, which causes the round surface 23 of mandrel 1 to contact hole 20 in workpiece 19. The working fluid, pushed by piston 1 passes through piston chamber 32 of hydrocylinder 4, the left section of distributor 37, the filter 42 and enters tank 43. The motion speed of mandrel 1 is adjusted by the position of throttle control 79. When pressure at the entry of relief valve 81 reaches the value the valve is adjusted to, the said opens and the right section of the hydraulically controlled distributor 80 is switched over. The working fluid, fed by pump 38, passes through the left section of distributor 37, the right section of distributor 80, flow regulator 75, check valve 74 and enters rod chamber 34. Piston 5, together with the whole tool 100, starts moving to the right, which causes conical surfaces 16 and round surfaces 22 of the working parts 17 of mandrel 1 to pass through the preliminary drilled hole 20 in workpiece 19, deforming it plastically. The working fluid, pushed from the piston chamber of hydrocylinder 4, passes through the left section of distributor 37, filer 42 and enters tank 43. The motion speed of piston 5 is set by adjusting the flow regulator 75.

When the device is executed according to FIG. 9, after ICU 35 supplies voltage to electromagnet 36 of distributor 37 (FIG. 12), its adjacent right section is switched on. This causes the working fluid, fed by pump 38 to pass through the right section of distributor 37, to enter piston chamber 37 of cylinder 86 and simultaneously to enter chamber 83 of cylinder 4. The mandrel 5 of piston 4 starts moving to the left together with tool 100, pin 84 and second cylinder 86. The fluid, pushed from rod chamber 34, passes through throttle control 72, check valve 73, check valve 76, the right section of distributor 37, the filter 42 and enters tank 43. The motion speed is adjusted by the position of throttle control 72. After mandrel 5 reaches extreme left position, the system pressure increases and on reaching the value, to which the relief valve 77 is set to, the said opens. This causes the second piston 10, together with pin 3 of tool 100, to start moving to the left, and thus conical surface 13 of the pin is separated from conical surfaces 14 of mandrel 1. At that moment the operator inserts tool 100 in the hole of workpiece 19. The working fluid from rod chamber 65 passes through the relief valve 77, the left section of distributor 80, the right section of distributor 37, the filter 42 and enters tank 43. The motion speed is adjusted by the position of throttle control 72. After piston 10 reaches extreme left position, the system pressure increases and the relief-easing valve 44 opens, as the working fluid fed by pump 38 passes through it and enters tank 43. After ICU 35 supplies voltage to electromagnet 45 of distributor 37, its adjacent left section is switched on. This causes the working fluid, fed by pump 38 to pass through the left section of distributor 37, the left section of distributor 80, throttle control 79, check valve 78 and to enter rod chamber 65. Mandrel 10 starts moving to the right together with pin 3. The working fluid, pushed by mandrel 10, passes through piston chamber 87, the left section of distributor 37, filter 42 and enters tank 43. The motion speed of piston 10 is adjusted by the position of throttle control 79. After the round surface 23 of the mandrel contacts hole 20 of workpiece 19, mandrel 10 reaches extreme right position and the system pressure increases. When pressure at the entry of relief valve 81 reaches the value it is set to, the said opens and the right section of the hydraulically controlled distributor 80 is switched over. The working fluid, fed by pump 38, passes through the left section of distributor 37, the right section of distributor 80, the flow regulator 75, check valve 74 and enters rod chamber 34. Piston 5 starts moving to the right together with tool 100, mandrel 1 of which passes through the hole of workpiece 19 and thus cold expansion takes place. The working fluid pushed from the piston chamber of hydrocylinder 4, passes through the left section of distributor 37, filter 42 and enters tank 43.

When tool 100 is executed as per FIG. 5, the elastic elements 59 retract segments 49 back to their primary position of lateral contact after their radial shift and facilitate the insertion of mandrel 1 of tool 100 in the preliminary drilled hole 20 in workpiece 19.

### CITATION LIST

1. U.S. Pat. No. 4,665,732.

1. A tool for cold expansion of holes, comprising a mandrel longitudinally split, so that at least three symmetrical segments are formed in it, its working part, formed by outer rotation surfaces and a round, axially mobile pin, inserted in an axial hole of the mandrel, characterized in that the working part (17) of the mandrel (1) is formed by two conical surfaces, (16) and (33) connected to each other by a round face (22), the other end of the round pin (3) has conical surface(13), contacting the surface (14) of a conical hole (15), machined in the split end of the mandrel (1), as the conical surfaces (13) and (14) have one and the same inclination angle α and expanding direction to the split end of the mandrel (1), a conical surface (16) of the working part (17) of the mandrel (1) passes into a round surface (23) of the mandrel 91), each segment (49) of the working part (17) of the mandrel (1), via its conical surface 914) contacts the conical surface (13) of the pin (3) only by one generatrix line, lying in the plane of symmetry of the respective segment, for each reciprocal position in axial direction of the segments (49) and the pin (3), on the unsplit part (7) of the mandrel 91) thread (25) is formed for connecting the tool (100) to the device (200), and the second end of the pin (3) is joined separately from the mandrel (1) to the device (200) via a thread joint (94) or in another suitable way.

2. A tool according to claim 1, characterized in that the mandrel (1) is entirely split, from the one end to the other, to separate segments (49), touching each other laterally without clearance, set with the possibility of only radial shift in a cylinder threaded screw (52) with thread (58) formed in it for connecting the tool (100) to the device (200), a second conical surface (50) is machined on the pin (3), contacting a second conical surface (51) of the axial hole(2) of the mandrel (1), as the conical surfaces (50) and (51) expand in the same direction as the conical surface (13) and have the same inclination angle α, the second conical plane (50) is machined by sectors (57), statically set to the respective segments (49) between a round surface (53), machined on the segments (49) and an inner round surface (54), machined on the sleeve (52), an elastic element (55) is inserted with elasticity in radial direction; around the outer round surfaces (56) of the segments (49) one or more elastic elements (59) are clamped, each sector (57), via its conical plane (51) contacts the second conical surface (50) of the pin (3) only by one generatrix line, lying in the plane of symmetry of the respective sector, for each reciprocal position in axial direction of the sectors (57) and the pin (3), with the exception of this reciprocal position, corresponding to the case, when the machined hole is preliminary drilled at the upper limit of its diameter tolerance, as the same condition is also fulfilled regarding the contact between the conical surfaces (14) of the segments (49) and conical surface (13) of the free pin end (3).

3. A tool according to claim 2, characterized in that the surface (20) of the hole, preliminary drilled in the workpiece (19) with the respective tolerance, is an enveloping round surface of the rotational outer surfaces (23) of the segments (49), which surfaces (23) form a discrete outer round surface, coinciding with the enveloping round surface (20) of the preliminary drilled hole, when this hole is drilled at the upper limit of its diameter tolerance.

4. A tool according to claim 1, characterized in that the α angle is smaller or equal to the angle of friction between the respective contacting surfaces of the pin (3) and the mandrel (1).

5. A tool according to claim 1, characterized in that the number of segments (49) is from 2 to 7 or from 9 to 16 incl.

6. A device for cold expansion of holes, comprising a first cylinder, in which a first piston with a piston rod is inserted, tot eh end of which the mandrel of the tool is coaxially clamped, with an axial hole, machined in the first piston and its piston rod, a second cylinder coaxial to the first with a second piston inserted in it, connected with a second piston rod, the end of which is statically connected to the pin of the tool, at least two chambers, formed by the spaces, enclosed by the two cylinders and their pistons and rods and driving and control systems, characterized in that the second piston (10) is inserted in the axial hole (8), in which, on the side of the mandrel, a distance sleeve (11) is statically clamped, and between the second piston (10) and the sleeve (11), a spring (12) working under pressure is inserted, the front faces (26) and (27) of the first piston (5) and second piston (10), the surface (28) of the axial hole (8) in the first piston (5), the surface (29) of the cylinder (4), the front face (96) and the inner round surface (95) of the sleeve (60) and the front face (30) of the bottom (31) of the cylinder (4) form a joint piston chamber (32), and the cylinder (4), the first piston (5) and its piston rod (6) form a rod chamber (34), coaxially to the cylinder (4), in direction to the split end of the mandrel (1), a flange (18) is statically clamped, its inner round surface (21), limiting the maximal diameter of the round surface, circumscribed around the round surfaces 922) of the working part (17) of the mandrel (1), between the first mandrel (5) and the bottom of the cylinder (4) a shoulder (24) is provided for, limiting the piston (5) stroke, and the systems for driving and control are joined in one joint driving-control system.

7. A device according to claim 6, characterized in that the driving-control system comprises a hydraulic pump 938), serially connected to a relief-easing valve (44) and to a central hydraulic distributor (37), controlled by electromagnets (36) and (45) via an instruction-control unit (35), and connected to the piston chamber (32) of the cylinder (4) via serially connected first “throttle control-check valve” unit (39) and s second hydraulically controlled distributor (40), the rod chamber (34) is connected to the central hydraulic distributor (37) via a second throttle control-check valve” unit (41), and between the central (37) and second (40) hydraulic distributors a check valve (47) and a flow regulator (46 are serially connected.

8. A device according to claim 6, characterized in that a surface (62) of the second piston (10), limited by the second piston rod (9), the round surface (63) of the piston rod (9), the surface (28) of the axial hole (8) in the first piston (5) and front face (64), limited by the axial hole (8) in the first piston (5) and in the first piston rod (6), form a second rod hydraulic chamber (65), and via a radial hole (66), machined in the first piston rod (6), the second rod hydraulic chamber (65) is connected to a distributing hydraulic chamber (67), coaxial to the second rod chamber (65) and formed by the round surface (68) of the first piston rod (6), a concentric round surface (69) of the cylinder (4) and two front faces (70), machine din the housing of the hydraulic cylinder (4), as the axial length of the distributing hydraulic chamber (67) is bigger than the axial stroke of the first piston (5).

9. A device according to claim 6, characterized in that to the first piston (5) a cylinder sleeve (84) is coaxially machined or statically clamped, the sleeve is set in the hole of a lid (85), connected via thread (97) or flange joint to the hydraulic cylinder (4), in the axial hole (89) of the cylinder sleeve (84) the pin (3) of the tool (100) is inserted, so that the outer surface (90) of the sleeve (84), the inner round surface (91) of the cylinder (4), the front face (26) of the piston (5) and the bottom (92) of the lid (85) form a piston chamber (83), to the cylinder sleeve (84) a second hydraulic cylinder (86) coaxially is machined or statically clamped, in which the second piston (10) is set, and to its piston rod (9) the pin (3) of the tool (100) is statically clamped, as the second cylinder (86) is closed by lid (88), which together with the front face (27) of the second piston (10) and second cylinder (86), for a second piston chamber (87).

10. The device according to claim 7, characterized in that the driving-control system comprises a hydraulic pump (38), serially connected to a relief-easing valve (44) and to a central hydraulic distributor (37), controlled by electromagnets (36) and (45) via an instruction-control unit (35), and connected to the piston chamber (32) of the cylinder (4), the rod chamber (34) of the cylinder (4) is connected to the hydraulic distributor (37) via two parallel circuits, as the first circuit comprises a serially connected throttle (72), a check valve (73) and a second check valve (76), and the second circuit in direction from the hydraulic distributor (37) to the chamber (34) comprises serially connected relief valve (81), a hydraulically controlled distributor (80), a flow regulator (75) and a check valve (74), as parallel connected to relief valve (81) is a check valve (82), the second rod chamber (65) is connected to the hydraulic distributor (37) by two parallel circuits, the first of which comprises a relief valve (77) and a hydraulically controlled distributor (80), and the second, in direction from the hydraulic distributor 937) to the inner rod chamber (65), comprises a hydraulically controlled distributor (80), a throttle (79) and a check valve (78).

11. The device according to claim 8, characterized in that the driving-control system comprises a hydraulic pump (38), serially connected to a relief-easing valve (44) and to a central hydraulic distributor (37), controlled by electromagnets (36) and (45) via an instruction-control unit (35), and connected to the piston chamber (32) of the cylinder (4), the rod chamber (34) of the cylinder (4) is connected to the hydraulic distributor (37) via two parallel circuits, as the first circuit comprises a serially connected throttle (72), a check valve (73) and a second check valve (76), and the second circuit in direction from the hydraulic distributor (37) to the chamber (34) comprises serially connected relief valve (81), a hydraulically controlled distributor (80), a flow regulator (75) and a check valve (74), as parallel connected to relief valve (81) is a check valve (82), the second rod chamber (65) is connected to the hydraulic distributor (37) by two parallel circuits, the first of which comprises a relief valve (77) and a hydraulically controlled distributor (80), and the second, in direction from the hydraulic distributor 937) to the inner rod chamber (65), comprises a hydraulically controlled distributor (80), a throttle (79) and a check valve (78).

12. A tool according to claim 1, characterized in that the number of segments (49) is from 2 to 7 or from 9 to 16 incl.

13. A tool according to claim 2, characterized in that the α angle is smaller or equal to the angle of friction between the respective contacting surfaces of the pin (3) and the mandrel (1).

14. A tool according to claim 13, characterized in that the number of segments (49) is from 2 to 7 or from 9 to 16 incl.

15. A tool according to claim 2, characterized in that the number of segments (49) is from 2 to 7 or from 9 to 16 incl.

16. A tool according to claim 3, characterized in that the α angle is smaller or equal to the angle of friction between the respective contacting surfaces of the pin (3) and the mandrel (1).

17. A tool according to claim 16, characterized in that the number of segments (49) is from 2 to 7 or from 9 to 16 incl.

18. A tool according to claim 3, characterized in that the number of segments (49) is from 2 to 7 or from 9 to 16 incl.

19. A tool according to claim 4, characterized in that the number of segments (49) is from 2 to 7 or from 9 to 16 incl.
